(19) United States
(12) Patent Application Publication
(10) Pub. No.: US 2022/0301080 A1
(43) Pub. Date: Sep. 22, 2022

(54) DETERMINING UNCERTAINTY OF AGRONOMIC PREDICTIONS

(71) Applicant: Climate LLC, San Francisco, CA (US)

(72) Inventors: Rosa Maria CATALA LUQUE, Mill Valley, CA (US); Jennifer HOLT, San Francisco, CA (US); Kevin WIERMAN, Seattle, WA (US); Timothy Tao Hin LAW, London (GB); Gardar JOHANNESSON, Oakland, CA (US); Julien VARENNES, Oakland, CA (US)

(73) Assignee: Climate LLC, San Francisco, CA (US)

(21) Appl. No.: 17/698,672

(22) Filed: Mar. 18, 2022

Related U.S. Application Data
(60) Provisional application No. 63/163,652, filed on Mar. 19, 2021.

(51) Int. Cl. G06Q 50/02; G06N 3/04

(52) U.S. Cl. CPC G06Q 50/02; G06N 3/0472; G06N 3/0454; G06N 3/0436

(57) ABSTRACT

The present disclosure relates generally to agronomic modeling, and more specifically to determining uncertainty associated with agronomic predictions (e.g., agricultural yield of a field). An exemplary method comprises: receiving information associated with a location; providing the information to one or more trained machine-learning models; determining, based on the trained machine-learning models: a probabilistic distribution of the predicted crop yield of the location, wherein the probabilistic distribution is defined by a plurality of parameters; and an uncertainty measure associated with a moment of the probabilistic distribution of the predicted crop yield.

### CROSS-REFERENCE TO RELATED APPLICATION

This application claims the benefit of U.S. Provisional Application 63/163,652 filed on Mar. 19, 2021, the entire contents of which are incorporated herein by reference for all purposes.

### COPYRIGHT NOTICE

A portion of the disclosure of this patent document contains material subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2021 The Climate Corporation.

### FIELD OF INVENTION

The present disclosure relates generally to agronomic modeling, and more specifically to determining uncertainty associated with agronomic predictions (e.g., agricultural yield of a field). Examples of the present disclosure solve a number of technical problems, including providing a computer-aided design solution for agricultural field management.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Optimizing the planting practices and the management of agricultural fields can be extremely difficult. There is a vast array of options (e.g., planting techniques, management techniques, and hybrid seeds) available to a farmer, but testing different agricultural techniques can be time-consuming and labor-intensive and can negatively affect crop yield. Differences among different agricultural fields can further exacerbate these difficulties.

Computer modeling of the agricultural yield (also referred to as “crop yield”) prior to planting a field may potentially decrease the likelihood that the testing negatively affects the agricultural yield. However, computer models configured to output a point-based prediction of the agricultural yield (e.g., a single number representing the yield prediction) can still lead to situations where large-scale testing of agricultural techniques on different fields can lead to an overall decrease in crop yield. Thus, there is a need for a system that can provide a more nuanced, probabilistic prediction of the agricultural yield (e.g., a probabilistic distribution representing the yield prediction).

Further, when a model is presented with input data that significantly deviates from the training data, it is expected that the model will have low confidence in the output prediction. However, the model would still output the prediction without indicating the low confidence associated with it. Thus, there is a need for providing model uncertainty associated with the model output. More specifically, there is a need for providing model uncertainty associated with a probabilistic prediction provided by a computer model (of an agricultural yield or any other agronomic metrics).

### DESCRIPTION OF THE FIGURES

The appended claims may serve as a summary of the disclosure.

In the drawings:

FIG. 1 illustrates an example computer system that is configured to perform the functions described herein, shown in a field environment with other apparatus with which the system may interoperate.

FIG. 2A and FIG. 2B illustrate two views of an example logical organization of sets of instructions in main memory when an example mobile application is loaded for execution.

FIG. 3 illustrates a programmed process by which the agricultural intelligence computer system generates one or more preconfigured agronomic models using agronomic data provided by one or more data sources.

FIG. 4 is a block diagram that illustrates a computer system upon which an embodiment of the invention may be implemented.

FIG. 5 depicts an example embodiment of a timeline view for data entry.

FIG. 6 depicts an example embodiment of a spreadsheet view for data entry.

FIG. 7 illustrates an exemplary process for determining a probabilistic distribution of a predicted agricultural yield of a location and uncertainty associated the probabilistic distribution, in accordance with some embodiments.

FIG. 8A illustrates one or more exemplary machine-learning models, in accordance with some embodiments.

FIG. 8B illustrates one or more exemplary machine-learning models, in accordance with some embodiments.

FIG. 8C illustrates an exemplary application of dropout, in accordance with some embodiments.

FIG. 9A illustrates results of an exemplary plurality of simulations, according to some embodiments.

FIG. 9B illustrates results of an exemplary plurality of simulations, according to some embodiments.

FIG. 10A illustrates a diagram of uncertainty values corresponding to a plurality of geographic regions, in accordance with some embodiments.

FIG. 10B illustrates a corresponding map view of the plurality of geographic regions, in accordance with some embodiments.

FIG. 11A illustrates an exemplary scenario in which the model is overconfident, in accordance with some embodiments.

FIG. 11B illustrates an exemplary scenario in which the model is uncertain, in accordance with some embodiments.

FIG. 12 illustrates an exemplary process for training one or more machine-learning models, in accordance with some embodiments.

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure. Embodiments are disclosed in sections according to the following outline:

1. GENERAL OVERVIEW

2. EXAMPLE AGRICULTURAL INTELLIGENCE COMPUTER SYSTEM
2.1. STRUCTURAL OVERVIEW
2.2. APPLICATION PROGRAM OVERVIEW
2.3. DATA INGEST TO THE COMPUTER SYSTEM
2.4. PROCESS OVERVIEW-AGRONOMIC MODEL TRAINING
2.5. IMPLEMENTATION EXAMPLE-HARDWARE OVERVIEW

3. EXTENSIONS AND ALTERNATIVES

4. AGRONOMIC MODEL UNCERTAINTY
4.1. DETERMINING MODEL UNCERTAINTY
4.2. GENERALIZATION
4.3. EVALUATING AND IMPROVING MODEL PERFORMANCE
4.4. USE OF MODEL OUTPUTS
4.5. MODEL TRAINING

### 1. General Overview

Disclosed herein are systems, devices, apparatuses, methods, and non-transitory storage media for determining uncertainty associated with a probabilistic distribution predicted by a model. A model may describe how an output of a mathematical function is computed given an input. In some embodiments, the probability distribution may represent a predicted crop yield at a location, where the location may be a field of a field zone. In some examples, a probability distribution comprises a statistical function that describes some or all the possible values and likelihoods that a random variable (i.e., the predicted crop yield) can take within a given range. This range may be bounded between the minimum and maximum possible values, but precisely where the possible value is likely to be plotted on the probability distribution depends on a number of factors. The model can be a parametric model or a non-parametric model such as a neural network. In some embodiments, an exemplary system performs a plurality of simulations to obtain a plurality of simulated probabilistic distributions. Based on the plurality of simulated probabilistic distributions, the system can calculate a plurality of moment values (e.g., a plurality of simulated expectation values) and then calculate an uncertainty associated with the moment (e.g., an uncertainty associated with the expectation value). Simulations can be performed using various techniques. In some embodiments, simulations are performed by applying dropout in a neural network. In some embodiments, simulations are performed using bootstrapping.

An exemplary computer-implemented method of predicting a crop yield for a location and uncertainty associated with the predicted crop yield comprises: receiving information associated with the location; providing the information to one or more trained machine-learning models; determining, based on the trained machine-learning models: the predicted crop yield of the location comprising a probabilistic distribution of the predicted crop yield of the location, wherein the probabilistic distribution is defined by a plurality of parameters; and an uncertainty measure associated with a moment of the probabilistic distribution of the predicted crop yield; and outputting the predicted crop yield of the location and the uncertainty measure.

In some embodiments, the method further comprises determining a farming recommendation based on the predicted crop yield.

In some embodiments, the farming recommendation is related to crop type, irrigation, planting, fertilizer, fungicide, pesticide, harvesting, or any combination thereof.

In some embodiments, the method further comprises determining a risk associated with the farming recommendation based on the uncertainty measure.

In some embodiments, the one or more models are trained based on harvest data, soil data, planting data, fertilizing data, chemical application data, irrigation data, weather data, imagery data, scouting observations, or any combination thereof.

In some embodiments, the one or more trained machine-learning models comprise one or more neural network models.

In some embodiments, the one or more trained machine-learning models comprises a neural network trained with a dropout layer.

In some embodiments, the probability distribution is a SHASH distribution.

In some embodiments, the plurality of parameters are center, skew, scale, and kurtosis.

In some embodiments, the moment is one of the plurality of parameters.

In some embodiments, the moment is an expectation value of the probabilistic distribution.

In some embodiments, the method further comprises running a plurality of simulations using a neural network model of the one or more machine-learning models to obtain a plurality of simulated values of the moment.

In some embodiments, running the plurality of simulations comprises performing T stochastic forward passes through the neural network model, wherein a network unit of the neural network model is perturbed in each simulation of the plurality of simulations.

In some embodiments, the uncertainty measure is calculated based on the plurality of simulated values of the moment.

In some embodiments, the uncertainty measure is a standard deviation calculated based on the plurality of simulated values of the moment.

In some embodiments, the one or more machine-learning model comprise a first model and a second model, wherein the first model is used to determine the probabilistic distribution of the predicted agricultural yield of the location, and wherein the second model is used to determine the uncertainty measure.

In some embodiments, the method further comprises running a plurality of simulations using a neural network model of the one or more machine-learning models to obtain a plurality of simulated probabilistic distributions; based on the plurality of simulated probabilistic distributions, determining the probabilistic distribution of the predicted agricultural yield of the location; and based on the plurality of simulated probabilistic distributions, determining the uncertainty measure associated with the moment of the probabilistic distribution.

In some embodiments, the method further comprises if the uncertainty measure exceeds a predefined threshold, obtaining additional training data to train the one or more machine-learning models and training the one or more machine-learning models based on the additional training data.

In some embodiments, the information associated with the location comprises recommendation data relating a crops management activity to be conducted at the location, the method further comprising: determining whether the uncertainty measure exceeds a predefined threshold; in accordance with a determination that the uncertainty measure does not exceed the predefined threshold, displaying the recommendation data; and in accordance with a determination that the uncertainty measure exceeds the predefined threshold, foregoing displaying the recommendation data.

In some embodiments, the information associated with the location comprises recommendation data relating a crops management activity to be conducted at the location, the method further comprising: obtaining optimized recommendation data by iteratively running the one or more trained machine-learning models using different recommendation data until the uncertainty measure does not exceed a first predefined threshold and the probabilistic distribution exceeds a second predefined threshold; and displaying the optimized recommendation data.

In some embodiments, the method further comprises operating a farming equipment based on the recommendation data.

In some embodiments, the information associated with the location is in the form of a matrix or an array.

An exemplary electronic device for predicting a crop yield for a location and uncertainty associated with the predicted crop yield, comprises: one or more processors; a memory; and one or more programs, wherein the one or more programs are stored in the memory and configured to be executed by the one or more processors, the one or more programs including instructions for receiving information associated with the location; providing the information to one or more trained machine-learning models; determining, based on the trained machine-learning models: the predicted crop yield of the location comprising a probabilistic distribution of the predicted crop yield of the location, wherein the probabilistic distribution is defined by a plurality of parameters; and an uncertainty measure associated with a moment of the probabilistic distribution of the predicted crop yield; and outputting the predicted crop yield of the location and the uncertainty measure.

An exemplary non-transitory computer-readable storage medium stores one or more programs for predicting a crop yield for a location and uncertainty associated with the predicted crop yield, the one or more programs comprising instructions, which when executed by one or more processors of an electronic device having a display, cause the electronic device to: receive information associated with the location; provide the information to one or more trained machine-learning models; determine, based on the trained machine-learning models: the predicted crop yield of the location comprising a probabilistic distribution of the predicted crop yield of the location, wherein the probabilistic distribution is defined by a plurality of parameters; and an uncertainty measure associated with a moment of the probabilistic distribution of the predicted crop yield; and output the predicted crop yield of the location and the uncertainty measure.

### 2. Example Agricultural Intelligence Computer System

2.1 Structural Overview

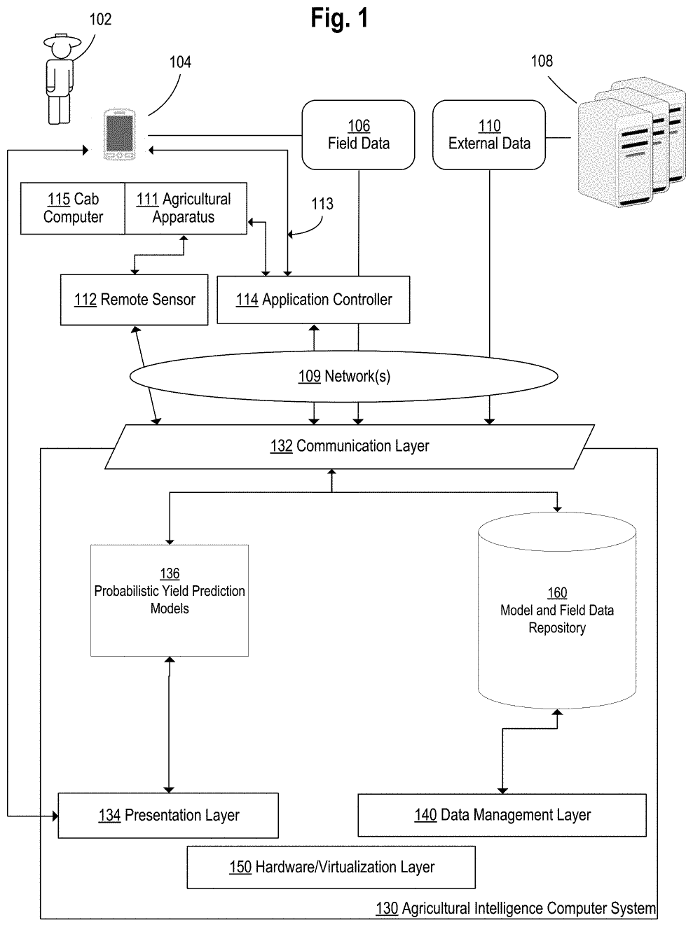

FIG. 1 illustrates an example computer system configured to perform the functions described herein, shown in a field environment with other apparatus with which the system may interoperate. In one embodiment, a user 102 owns, operates or possesses a field manager computing device 104. In some embodiments, the field manager computing device 104 is located in a field location or associated with a field location (e.g., a field intended for agricultural activities or a management location for one or more agricultural fields). In some embodiments, the field manager computing device 104 is a mobile device. The field manager computer device 104 is programmed or configured to provide field data 106 to an agricultural intelligence computer system 130 via one or more networks 109.

Examples of field data 106 include (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), and/or (k) soil, seed, crop phenology, pest and disease reporting, and predictions sources and databases.

One or more data server computers 108 are communicatively coupled to agricultural intelligence computer system 130 and are programmed or configured to send external data 110 to agricultural intelligence computer system 130 via the network(s) 109. The external data server computer 108 may be owned or operated by the same legal person or entity as the agricultural intelligence computer system 130, or by a different person or entity such as a government agency, non-governmental organization (NGO), and/or a private data service provider. Examples of external data include weather data, imagery data, soil data, or statistical data relating to crop yields, among others. External data 110 may comprise the same type of information as field data 106. In some embodiments, the external data 110 is provided by one or more external data servers 108 owned by the same entity that owns and/or operates the agricultural intelligence computer system 130. For example, the agricultural intelligence computer system 130 may include a data server focused exclusively on a type of data that might otherwise be obtained from third party sources, such as weather data. In some embodiments, an external data server 108 may actually be incorporated within the system 130.

An agricultural apparatus 111 may have one or more remote sensors 112 fixed thereon, which sensors are communicatively coupled either directly or indirectly via agricultural apparatus 111 to the agricultural intelligence computer system 130 and are programmed or configured to send sensor data to agricultural intelligence computer system 130. Examples of agricultural apparatus 111 include tractors, combines, harvesters, planters, trucks, fertilizer equipment, aerial vehicles including unmanned aerial vehicles, and any other item of physical machinery or hardware, typically mobile machinery, and which may be used in tasks associated with agriculture. In some embodiments, a single unit of apparatus 111 may comprise a plurality of sensors 112 that are coupled locally in a network on the apparatus; controller area network (CAN) is example of such a network that can be installed in combines, harvesters, sprayers, and cultivators. Application controller 114 is communicatively coupled to agricultural intelligence computer system 130 via the network(s) 109 and is programmed or configured to receive one or more scripts that are used to control an operating parameter of an agricultural vehicle or implement from the agricultural intelligence computer system 130. For instance, a controller area network (CAN) bus interface may be used to enable communications from the agricultural intelligence computer system 130 to the agricultural apparatus 111, such as how the CLIMATE FIELDVIEW DRIVE, available from The Climate Corporation, San Francisco, Calif., is used. Sensor data may comprise the same type of information as field data 106. In some embodiments, remote sensors 112 may not be fixed to an agricultural apparatus 111 but may be remotely located in the field and may communicate with network 109.

The apparatus 111 may comprise a cab computer 115 that is programmed with a cab application, which may comprise a version or variant of the mobile application for device 104 that is further described in other sections herein. In an embodiment, cab computer 115 comprises a compact computer, often a tablet-sized computer or smartphone, with a graphical screen display, such as a color display, that is mounted within an operator's cab of the apparatus 111. Cab computer 115 may implement some or all of the operations and functions that are described further herein for the mobile computer device 104.

The network(s) 109 can include any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The sensors 112, controller 114, external data server computer 108, and other elements of the system each comprise an interface compatible with the network(s) 109 and are programmed or configured to use standardized protocols for communication across the networks such as TCP/IP, Bluetooth, CAN protocol and higher-layer protocols such as HTTP, TLS, and the like.

Agricultural intelligence computer system 130 is programmed or configured to receive field data 106 from field manager computing device 104, external data 110 from external data server computer 108, and sensor data from remote sensor 112. Agricultural intelligence computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In an embodiment, agricultural intelligence computer system 130 is programmed with or comprises a communication layer 132, presentation layer 134, data management layer 140, hardware/virtualization layer 150, and model and field data repository 160. A layer can include any combination of electronic digital interface circuits, microcontrollers, firmware such as drivers, and/or computer programs or other software elements.

Communication layer 132 may be programmed or configured to perform input/output interfacing functions including sending requests to field manager computing device 104, external data server computer 108, and remote sensor 112 for field data, external data, and sensor data respectively. Communication layer 132 may be programmed or configured to send the received data to model and field data repository 160 to be stored as field data 106.

Presentation layer 134 may be programmed or configured to generate a graphical user interface (GUI) to be displayed on field manager computing device 104, cab computer 115 or other computers that are coupled to the system 130 through the network 109. The GUI may comprise controls for inputting data to be sent to agricultural intelligence computer system 130, generating requests for models and/or recommendations, and/or displaying recommendations, notifications, models, and other field data.

Data management layer 140 may be programmed or configured to manage read operations and write operations involving the repository 160 and other functional elements of the system, including queries and result sets communicated between the functional elements of the system and the repository. Examples of data management layer 140 include JDBC, SQL server interface code, and/or HADOOP interface code, among others. Repository 160 may comprise a database. A database can include either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of the RDBMSes include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data 106 is not provided directly to the agricultural intelligence computer system via one or more agricultural machines or agricultural machine devices that interacts with the agricultural intelligence computer system, the user may be prompted via one or more user interfaces on the user device (served by the agricultural intelligence computer system) to input such information. In an example embodiment, the user may specify identification data by accessing a map on the user device (served by the agricultural intelligence computer system) and selecting specific CLUs that have been graphically shown on the map. In an alternative embodiment, the user 102 may specify identification data by accessing a map on the user device (served by the agricultural intelligence computer system 130) and drawing boundaries of the field over the map. Such CLU selection or map drawings represent geographic identifiers. In alternative embodiments, the user may specify identification data by accessing field identification data (provided as shape files or in a similar format) from the U.S. Department of Agriculture Farm Service Agency or other source via the user device and providing such field identification data to the agricultural intelligence computer system.

In an example embodiment, the agricultural intelligence computer system 130 is programmed to generate and cause displaying a graphical user interface comprising a data manager for data input. After one or more fields have been identified using the methods described above, the data manager may provide one or more graphical user interface widgets which when selected can identify changes to the field, soil, crops, tillage, or nutrient practices. The data manager may include a timeline view, a spreadsheet view, and/or one or more editable programs.

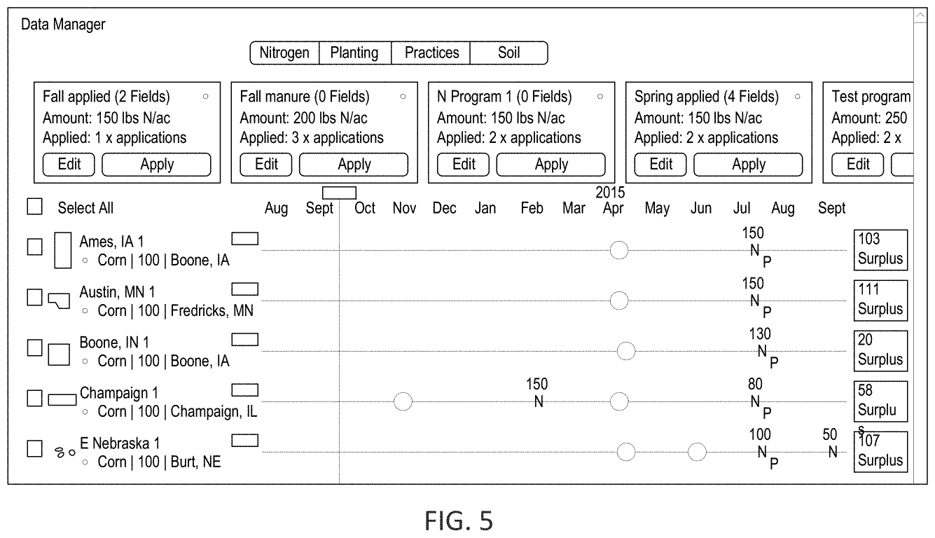

FIG. 5 depicts an example embodiment of a timeline view for data entry. Using the display depicted in FIG. 5, a user (or user computer) can input a selection of a particular field and a particular date for the addition of an event. Events depicted at the top of the timeline may include Nitrogen, Planting, Practices, and Soil. To add a nitrogen application event, a user may provide input to select the nitrogen tab. The user may then select a location on the timeline for a particular field in order to indicate an application of nitrogen on the selected field. In response to receiving a selection of a location on the timeline for a particular field, the data manager may display a data entry overlay, allowing the user to input data pertaining to nitrogen applications, planting procedures, soil application, tillage procedures, irrigation practices, or other information relating to the particular field. For example, if a user selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager provides an interface for creating one or more programs. A program can include a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 5, the top two timelines have the “Spring applied” program selected, which includes an application of 150 lbs N/ac in early April. The data manager may provide an interface for editing a program. In an embodiment, when a particular program is edited, each field that has selected the particular program is edited. For example, in FIG. 5, if the “Spring applied” program is edited to reduce the application of nitrogen to 130 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the top field in FIG. 5, the interface may update to indicate that the “Spring applied” program is no longer being applied to the top field. While the nitrogen application in early April may remain, updates to the “Spring applied” program would not alter the April application of nitrogen.

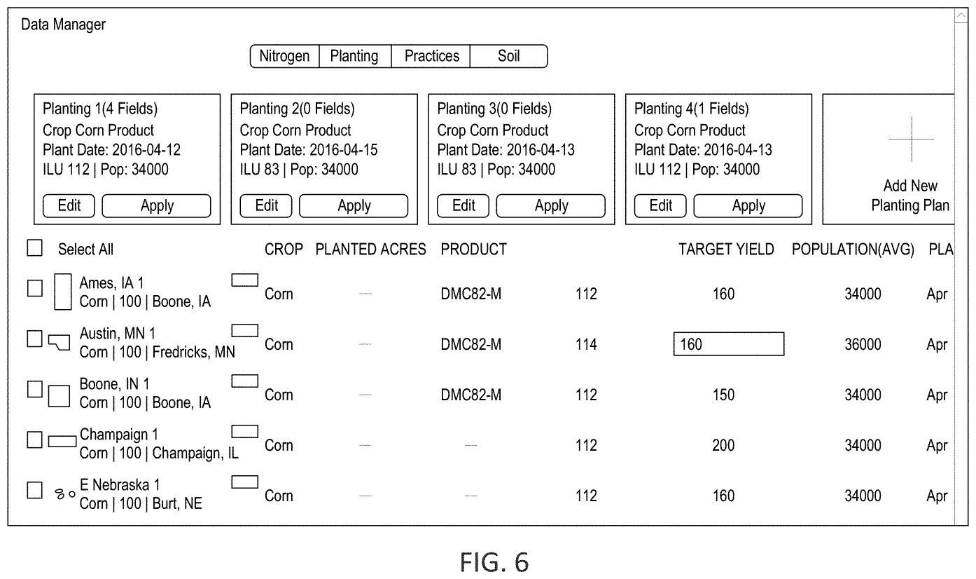

FIG. 6 depicts an example embodiment of a spreadsheet view for data entry. Using the display depicted in FIG. 6, a user can create and edit information for one or more fields. The data manager may include spreadsheets for inputting information with respect to Nitrogen, Planting, Practices, and Soil as depicted in FIG. 6. To edit a particular entry, a user may select the particular entry in the spreadsheet and update the values. For example, FIG. 6 depicts an in-progress update to a target yield value for the second field. Additionally, a user may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in model and field data repository 160. Model data comprises data models created for one or more fields. For example, a crop model may include a digitally constructed model of the development of a crop on the one or more fields. A model can include an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

In an embodiment, probabilistic yield prediction models 136 comprises a set of one or more pages of main memory, such as RAM, in the agricultural intelligence computer system 130 into which executable instructions have been loaded and which when executed cause the agricultural intelligence computing system to perform the functions or operations that are described herein with reference to those modules. For example, the probabilistic yield prediction models 136 may comprise a set of pages in RAM that contain instructions which when executed cause performing the yield prediction operations that are described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. A page can broadly include any region within main memory and the specific terminology used in a system may vary depending on the memory architecture or processor architecture. In another embodiment, the probabilistic yield prediction models 136 also may represent one or more files or projects of source code that are digitally stored in a mass storage device such as non-volatile RAM or disk storage, in the agricultural intelligence computer system 130 or a separate repository system, which when compiled or interpreted cause generating executable instructions which when executed cause the agricultural intelligence computing system to perform the functions or operations that are described herein with reference to those modules. In other words, the drawing figure may represent the manner in which programmers or software developers organize and arrange source code for later compilation into an executable, or interpretation into bytecode or the equivalent, for execution by the agricultural intelligence computer system 130.

Probabilistic yield prediction models 136 comprise computer readable instructions which, when executed by one or more processors, cause agricultural intelligence computer system 130 to predict yield on an agricultural field and uncertainty associated with the predicted yield.

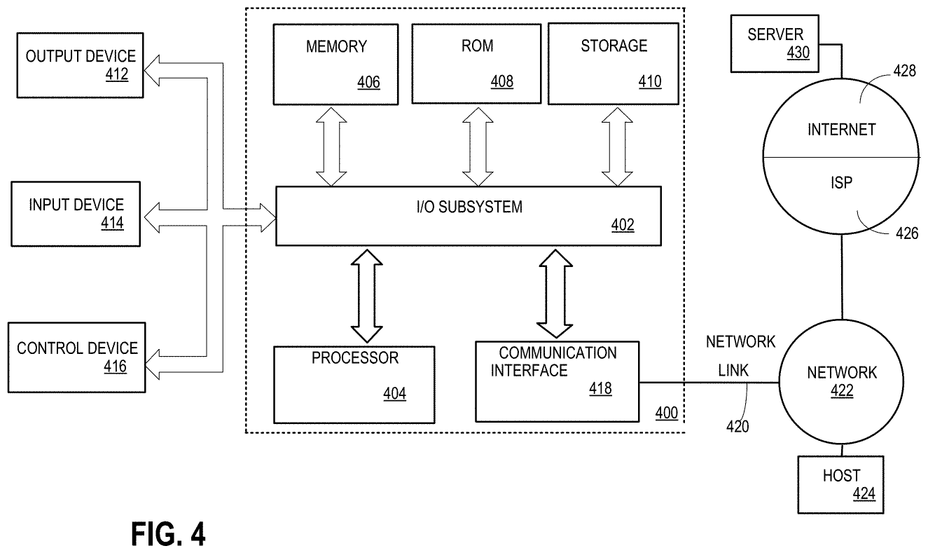

Hardware/virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 104 associated with different users. Further, the system 130 and/or external data server computer 108 may be implemented using two or more processors, cores, clusters, or instances of physical machines or virtual machines, configured in a discrete location or co-located with other elements in a datacenter, shared computing facility or cloud computing facility.

2.2. Application Program Overview

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for inventions and disclosures of this type.

In an embodiment, user 102 interacts with agricultural intelligence computer system 130 using field manager computing device 104 configured with an operating system and one or more application programs or apps; the field manager computing device 104 also may interoperate with the agricultural intelligence computer system independently and automatically under program control or logical control and direct user interaction is not always required. Field manager computing device 104 can include one or more of a smartphone, PDA, tablet computing device, laptop computer, desktop computer, workstation, or any other computing device capable of transmitting and receiving information and performing the functions described herein. Field manager computing device 104 may communicate via a network using a mobile application stored on field manager computing device 104, and in some embodiments, the device may be coupled using a cable 113 or connector to the sensor 112 and/or controller 114. A particular user 102 may own, operate or possess and use, in connection with system 130, more than one field manager computing device 104 at a time.

The mobile application may provide client-side functionality, via the network to one or more mobile computing devices. In an example embodiment, field manager computing device 104 may access the mobile application via a web browser or a local client application or app. Field manager computing device 104 may transmit data to, and receive data from, one or more front-end servers, using web-based protocols or formats such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 104, which determines the location of field manager computing device 104 using standard tracking techniques such as multilateration of radio signals, the global positioning system (GPS), Wi-Fi positioning systems, or other methods of mobile positioning. In some cases, location data or other data associated with the device 104, user 102, and/or user account(s) may be obtained by queries to an operating system of the device or by requesting an app on the device to obtain data from the operating system.

In an embodiment, field manager computing device 104 sends field data 106 to agricultural intelligence computer system 130 comprising or including, but not limited to, data values representing one or more of: a geographical location of the one or more fields, tillage information for the one or more fields, crops planted in the one or more fields, and soil data extracted from the one or more fields. Field manager computing device 104 may send field data 106 in response to user input from user 102 specifying the data values for the one or more fields. Additionally, field manager computing device 104 may automatically send field data 106 when one or more of the data values becomes available to field manager computing device 104. For example, field manager computing device 104 may be communicatively coupled to remote sensor 112 and/or application controller 114, which include an irrigation sensor and/or irrigation controller. In response to receiving data indicating that application controller 114 released water onto the one or more fields, field manager computing device 104 may send field data 106 to agricultural intelligence computer system 130 indicating that water was released on the one or more fields. Field data 106 identified in this disclosure may be input and communicated using electronic digital data that is communicated between computing devices using parameterized URLs over HTTP, or another suitable communication or messaging protocol.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

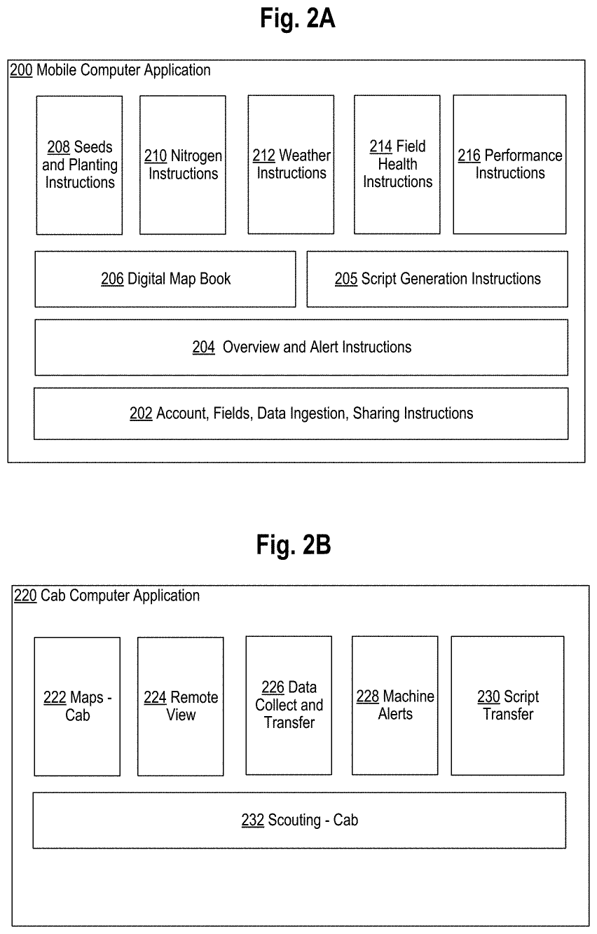

FIG. 2 illustrates two views of an example logical organization of sets of instructions in main memory when an example mobile application is loaded for execution. In FIG. 2, each named element represents a region of one or more pages of RAM or other main memory, or one or more blocks of disk storage or other non-volatile storage, and the programmed instructions within those regions. In one embodiment, in view (a), a mobile computer application 200 comprises account-fields-data ingestion-sharing instructions 202, overview and alert instructions 204, digital map book instructions 206, seeds and planting instructions 208, nitrogen instructions 210, weather instructions 212, field health instructions 214, and performance instructions 216.

In one embodiment, a mobile computer application 200 comprises account, fields, data ingestion, sharing instructions 202 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging and visual insights into field performance. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 205 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 200 may display one or more fields broken into management zones, such as the field map data layers created as part of digital map book instructions 206. In one embodiment, the management zones comprise soil zones along with a panel identifying each soil zone and a soil name, texture, drainage for each zone, or other field data. Mobile computer application 200 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 200 may make the script available for download in a format readable by an application controller, such as an archived or compressed format. Additionally, and/or alternatively, a script may be sent directly to cab computer 115 from mobile computer application 200 and/or uploaded to one or more data servers and stored for further use.

In one embodiment, nitrogen instructions 210 are programmed to provide tools to inform nitrogen decisions by visualizing the availability of nitrogen to crops. This enables growers to maximize yield or return on investment through optimized nitrogen application during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. A mass data entry can involve entering data once and then applying the same data to multiple fields and/or zones that have been defined in the system; example data may include nitrogen application data that is the same for many fields and/or zones of the same grower, but such mass data entry applies to the entry of any type of field data into the mobile computer application 200. For example, nitrogen instructions 210 may be programmed to accept definitions of nitrogen application and practices programs and to accept user input specifying to apply those programs across multiple fields. Nitrogen application programs can include stored, named sets of data that associates: a name, color code or other identifier, one or more dates of application, types of material or product for each of the dates and amounts, method of application or incorporation such as injected or broadcast, and/or amounts or rates of application for each of the dates, crop or hybrid that is the subject of the application, among others. Nitrogen practices programs can include stored, named sets of data that associates: a practices name; a previous crop; a tillage system; a date of primarily tillage; one or more previous tillage systems that were used; one or more indicators of application type, such as manure, that were used. Nitrogen instructions 210 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 210 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 210 could be used for application of other nutrients (such as phosphorus and potassium), application of pesticide, and irrigation programs.

In one embodiment, weather instructions 212 are programmed to provide field-specific recent weather data and forecasted weather information. This enables growers to save time and have an efficient integrated display with respect to daily operational decisions.

In one embodiment, field health instructions 214 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 216 may be programmed to communicate via the network(s) 109 to back-end analytics programs executed at agricultural intelligence computer system 130 and/or external data server computer 108 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to view (b) of FIG. 2, in one embodiment a cab computer application 220 may comprise maps-cab instructions 222, remote view instructions 224, data collect and transfer instructions 226, machine alerts instructions 228, script transfer instructions 230, and scouting-cab instructions 232. The code base for the instructions of view (b) may be the same as for view (a) and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms or regions that are useful in directing machine operation. The remote view instructions 224 may be programmed to turn on, manage, and provide views of machine activity in real-time or near real-time to other computing devices connected to the system 130 via wireless networks, wired connectors or adapters, and the like. The data collect and transfer instructions 226 may be programmed to turn on, manage, and provide transfer of data collected at sensors and controllers to the system 130 via wireless networks, wired connectors or adapters, and the like. The machine alerts instructions 228 may be programmed to detect issues with operations of the machine or tools that are associated with the cab and generate operator alerts. The script transfer instructions 230 may be configured to transfer in scripts of instructions that are configured to direct machine operations or the collection of data. The scouting-cab instructions 232 may be programmed to display location-based alerts and information received from the system 130 based on the location of the field manager computing device 104, agricultural apparatus 111, or sensors 112 in the field and ingest, manage, and provide transfer of location-based scouting observations to the system 130 based on the location of the agricultural apparatus 111 or sensors 112 in the field.

2.3. Data Ingest to the Computer System

In an embodiment, external data server computer 108 stores external data 110, including soil data representing soil composition for the one or more fields and weather data representing temperature and precipitation on the one or more fields. The weather data may include past and present weather data as well as forecasts for future weather data. In an embodiment, external data server computer 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil.

In an embodiment, remote sensor 112 comprises one or more sensors that are programmed or configured to produce one or more observations. Remote sensor 112 may be aerial sensors, such as satellites, vehicle sensors, planting equipment sensors, tillage sensors, fertilizer or insecticide application sensors, harvester sensors, and any other implement capable of receiving data from one or more fields. In an embodiment, application controller 114 is programmed or configured to receive instructions from agricultural intelligence computer system 130. Application controller 114 may also be programmed or configured to control an operating parameter of an agricultural vehicle or implement. For example, an application controller may be programmed or configured to control an operating parameter of a vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

The system 130 may obtain or ingest data under user 102 control, on a mass basis from a large number of growers who have contributed data to a shared database system. This form of obtaining data may be termed “manual data ingest” as one or more user-controlled computer operations are requested or triggered to obtain data for use by the system 130. As an example, the CLIMATE FIELDVIEW application, commercially available from The Climate Corporation, San Francisco, Calif., may be operated to export data to system 130 for storing in the repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed or configured to display seed spacing, population and other information to the user via the cab computer 115 or other devices within the system 130. Examples are disclosed in U.S. Pat. No. 8,738,243 and US Pat. Pub. 20150094916, and the present disclosure assumes knowledge of those other patent disclosures.

Likewise, yield monitor systems may contain yield sensors for harvester apparatus that send yield measurement data to the cab computer 115 or other devices within the system 130. Yield monitor systems may utilize one or more remote sensors 112 to obtain grain moisture measurements in a combine or other harvester and transmit these measurements to the user via the cab computer 115 or other devices within the system 130.

In an embodiment, examples of sensors 112 that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or Wi-Fi-based position or mapping apps that are programmed to determine location based upon nearby Wi-Fi hotspots, among others.

In an embodiment, examples of sensors 112 that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In an embodiment, examples of controllers 114 that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors 112 that may be used with seed planting equipment such as planters, drills, or air seeders include seed sensors, which may be optical, electromagnetic, or impact sensors; downforce sensors such as load pins, load cells, pressure sensors; soil property sensors such as reflectivity sensors, moisture sensors, electrical conductivity sensors, optical residue sensors, or temperature sensors; component operating criteria sensors such as planting depth sensors, downforce cylinder pressure sensors, seed disc speed sensors, seed drive motor encoders, seed conveyor system speed sensors, or vacuum level sensors; or pesticide application sensors such as optical or other electromagnetic sensors, or impact sensors. In an embodiment, examples of controllers 114 that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors 112 that may be used with tillage equipment include position sensors for tools such as shanks or discs; tool position sensors for such tools that are configured to detect depth, gang angle, or lateral spacing; downforce sensors; or draft force sensors. In an embodiment, examples of controllers 114 that may be used with tillage equipment include downforce controllers or tool position controllers, such as controllers configured to control tool depth, gang angle, or lateral spacing.

In an embodiment, examples of sensors 112 that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In an embodiment, examples of controllers 114 that may be used with such apparatus include pump speed controllers; valve controllers that are programmed to control pressure, flow, direction, PWM and the like; or position actuators, such as for boom height, subsoiler depth, or boom position.

In an embodiment, examples of sensors 112 that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers 114 that may be used with harvesters include header operating criteria controllers for elements such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors 112 that may be used with grain carts include weight sensors, or sensors for auger position, operation, or speed. In an embodiment, examples of controllers 114 that may be used with grain carts include controllers for auger position, operation, or speed.

In an embodiment, examples of sensors 112 and controllers 114 may be installed in unmanned aerial vehicle (UAV) apparatus or drones. Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosure.

In an embodiment, sensors 112 and controllers 114 may be affixed to soil sampling and measurement apparatus that is configured or programmed to sample soil and perform soil chemistry tests, soil moisture tests, and other tests pertaining to soil. For example, the apparatus disclosed in U.S. Pat. Nos. 8,767,194 and 8,712,148 may be used, and the present disclosure assumes knowledge of those patent disclosures.

In an embodiment, sensors 112 and controllers 114 may comprise weather devices for monitoring weather conditions of fields. For example, the apparatus disclosed in U.S. Provisional Application No. 62/154,207, filed on Apr. 29, 2015, U.S. Provisional Application No. 62/175,160, filed on Jun. 12, 2015, U.S. Provisional Application No. 62/198,060, filed on Jul. 28, 2015, and U.S. Provisional Application No. 62/220,852, filed on Sep. 18, 2015, may be used, and the present disclosure assumes knowledge of those patent disclosures.

2.4. Process Overview-Agronomic Model Training

In an embodiment, the agricultural intelligence computer system 130 is programmed or configured to create one or more agronomic models. An agronomic model includes a data structure in memory of the agricultural intelligence computer system 130 that comprises field data 106, such as identification data and harvest data for one or more fields. The agronomic model may also comprise calculated agronomic properties which describe either conditions which may affect the growth of one or more crops on a field, or properties of the one or more crops, or both. In some embodiments, an agronomic model can be trained based on the field data 106. Additionally, an agronomic model may comprise recommendations based on agronomic factors such as crop recommendations, irrigation recommendations, planting recommendations, fertilizer recommendations, fungicide recommendations, pesticide recommendations, harvesting recommendations and other crop management recommendations. In some embodiments, an agronomic model can be used to predict the above-described recommendations. The agronomic factors may also be used to estimate one or more crop related results, such as agronomic yield. The agronomic yield of a crop is an estimate of the quantity of the crop that is produced, or in some examples the revenue or profit obtained from the produced crop.

In an embodiment, the agricultural intelligence computer system 130 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truth that compares predicted results with actual results on a field, such as a comparison of precipitation estimate with a rain gauge or sensor providing weather data at the same or nearby location or an estimate of nitrogen content with a soil sample measurement.

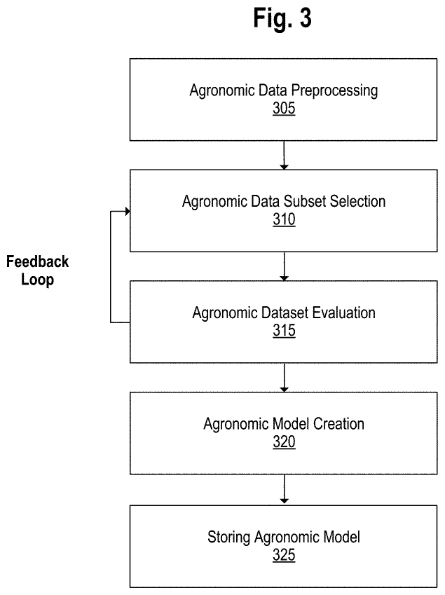

FIG. 3 illustrates a programmed process by which the agricultural intelligence computer system generates one or more preconfigured agronomic models using field data provided by one or more data sources. FIG. 3 may serve as an algorithm or instructions for programming the functional elements of the agricultural intelligence computer system 130 to perform the operations that are now described.

At block 305, the agricultural intelligence computer system 130 is configured or programmed to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 310, the agricultural intelligence computer system 130 is configured or programmed to perform data subset selection using the preprocessed field data in order to identify datasets useful for initial agronomic model generation. The agricultural intelligence computer system 130 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 315, the agricultural intelligence computer system 130 is configured or programmed to implement field dataset evaluation. In an embodiment, a specific field dataset is evaluated by creating an agronomic model and using specific quality thresholds for the created agronomic model. In an embodiment, an agronomic dataset evaluation logic is used as a feedback loop where agronomic datasets that do not meet configured quality thresholds are used during future data subset selection steps (block 310). The agronomic dataset evaluation logic can include verifying that data is within expected ranges and that their statistical properties (e.g., mean, median, quantiles) are within expected ranges. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed.

At block 320, the agricultural intelligence computer system 130 is configured or programmed to implement agronomic model creation based upon the cross validated agronomic datasets. This process can involve training the agronomic algorithm(s) on the validated agronomic dataset. In an embodiment, agronomic model creation may implement multivariate regression techniques to create preconfigured agronomic data models.

At block 325, the agricultural intelligence computer system 130 is configured or programmed to store the preconfigured agronomic data models for future field data evaluation.

2.5. Implementation Example-Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

Storage media can include any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infrared data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through a worldwide packet data communication network now commonly referred to as the Internet 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 3. Extensions and Alternatives

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

### 4. Model Uncertainty

Disclosed herein are systems, devices, apparatuses, methods, and non-transitory storage media for determining uncertainty associated with a probabilistic distribution (e.g., of an agronomic yield of a field) predicted by a model. The model can be a parametric model or a non-parametric model such as a neural network. In some embodiments, an exemplary system performs a plurality of simulations to obtain a plurality of simulated probabilistic distributions. Based on the plurality of simulated probabilistic distributions, the system can calculate an uncertainty associated with any moment (e.g., expectation) of the probabilistic distribution. Simulations can be performed using various techniques. In some embodiments, simulations are performed by applying dropout in a neural network. In some embodiments, simulations are performed using bootstrapping.

Embodiments of the present disclosure aim to provide a measurement of epistemic uncertainty (or model uncertainty or reducible uncertainty), which refers to uncertainty in the model itself. Epistemic uncertainty can be reduced by increasing training size. Epistemic uncertainty is distinct from aleatoric uncertainty (or data uncertainty or irreducible uncertainty), which refers to uncertainty with respect to information. More training data does not reduce aleatoric uncertainty, but increasing measurement precision (e.g., less noisy inputs) can reduce it.

Embodiments of the present disclosure can determine model uncertainty in an accurate and computationally efficient manner. While Bayesian probability theory offers mathematically grouped tools provide model uncertainty, these usually come with prohibitive computational cost. Dropout in neural networks, which is typically used as a way to avoid over-fitting, can be interpreted as a Bayesian approximation of the probabilistic Gaussian process. Embodiments of the present disclosure leverages dropout in a novel way to determine uncertainty associated with a predicted probabilistic distribution, specifically uncertainty associated with any moment of the predicted probabilistic distribution. This solves the problem of representing uncertainty in probabilistic models without sacrificing either computational complexity or test accuracy.

Model uncertainty allows better understanding of the modeling process and the dataset. For example, embodiments of the present disclosure can provide insight into when a model is not confident with the model outputs (e.g., if the uncertainty measure exceeds a predefined threshold), in which case more training data and/or input data can be provided to increase the model's confidence. The predefined threshold can be set to an uncertainty value above which the corresponding prediction to be considered not acceptable by the system to present to the user. As another example, embodiments of the present disclosure can detect when a model is under-confident (e.g., the uncertainty measure is high but the prediction matches empirical data) or falsely overconfident (e.g., the uncertainty measure is low but the prediction does not match empirical data). If a model is falsely overconfident or under-confident, the system may forego deploying the model and/or collecting new data to train the model.

Determining model uncertainty is especially important if the predictions are used in decision making, fed into other models or processes, and/or used to operate an agricultural implement. For example, the uncertainty associated with a moment of the probabilistic distribution can be used to determine the risk of a recommendation made based on the probabilistic distribution. A higher uncertainty value indicates a riskier recommendation. In some embodiments, pricing of the recommendation (e.g., the base price, the risk premium) can be adjusted based on the uncertainty value(s) associated with the moment(s) of the probabilistic distribution. In some embodiments, the recommendation and the associated certainty value may be used to determine how to control an agricultural implement performing future activities on the field.

4.1 Determining Model Uncertainty

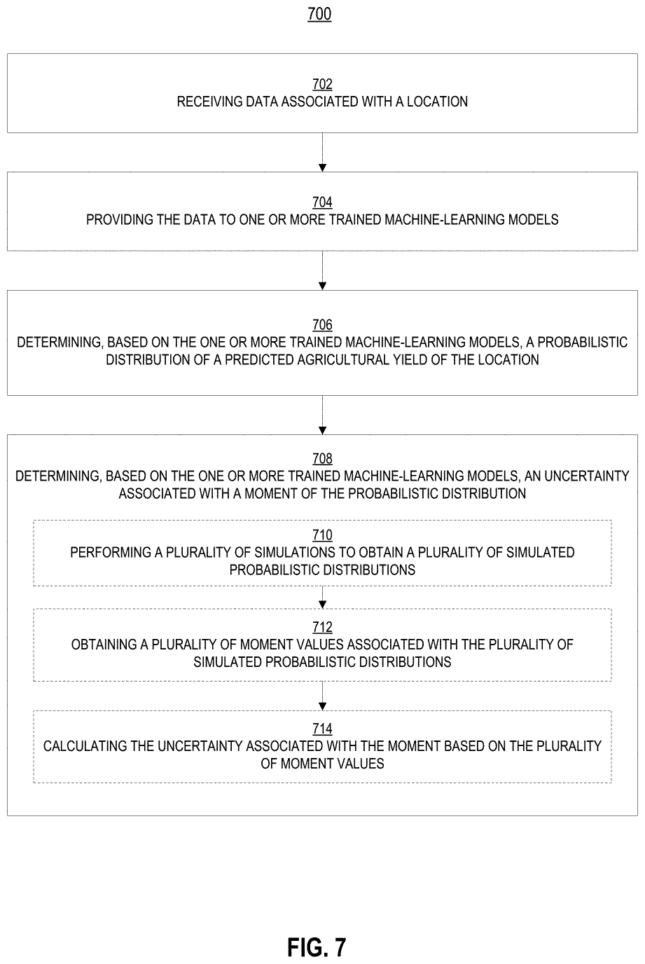

FIG. 7 illustrates an exemplary process for predicting a crop yield for a location and uncertainty associated with the predicted crop yield, in accordance with some embodiments. The agricultural yield at a location is a prediction of the quantity of crop(s) produced at the location, and can be quantified in different units such as volume, revenue, and profit of the produced crop. Process 700 is performed, for example, using one or more electronic devices implementing a software platform. In some examples, process 700 is performed using a client-server system, and the blocks of process 700 are divided up in any manner between the server and one or more client devices. Thus, while portions of process 700 are described herein as being performed by particular devices, it will be appreciated that process 700 is not so limited. In some examples, process 700 is performed using only a client device or only multiple client devices. In process 700, some blocks are, optionally, combined, the order of some blocks is, optionally, changed, and some blocks are, optionally, omitted. In some examples, additional steps may be performed in combination with the process 700. Accordingly, the operations as illustrated (and described in greater detail below) are exemplary by nature and, as such, should not be viewed as limiting.

At block 702, an exemplary system (e.g., one or more electronic devices) receives input data associated with the location. The location can be any geographical region, such as a plot, a field, a county, etc. In some embodiment, the input data includes measured data (e.g., provided by one or more sensors), predicted data, recommended data, or any combination thereof. In some examples, the input data is in the form of a matrix or an array.

The received data include information associated with the location. For example, the data may include agronomic properties describing conditions which may affect the growth of one or more crops on a field, or properties of the one or more crops, or both. In some embodiments, examples of received data 706 include (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, seed density, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), and (k) soil, seed, crop phenology, pest and disease reporting, and predictions sources and databases. When observed historical weather data (such as precipitation) are used as features in the model, a yield forecast may be made based on weather forecasts. Furthermore, probabilistic weather forecasts or multiple historical observations of weather can be sampled and input to the model to make probabilistic yield forecasts. Masking may be used to represent different missingness patterns of inputs, including weather and remotely sensed inputs like satellite imagery. In some embodiments, the received data comprises outputs from other models.

In some embodiments, the data includes previous yield data for one or more fields, the previous yield data comprising an agricultural yield of a field planted with a particular hybrid seed, soil characteristic data such as cation exchange capacity (CEC), field topology data such as field acreage, weather data such as precipitation, remotely sensed data such as satellite imagery, management practices such as seeding rate and occurrence or non-occurrence of crop rotation, and seed data such as traits of the particular hybrid seed. In some embodiments, the previous yield data comprises both corn and soy and their yields.

In some embodiments, examples of received data include management plans such as crop plans, irrigation plans, planting plans, fertilizer plans, fungicide plans, pesticide plans, harvesting plans, and other crop management plans. Specifically, the plans may include: seeding rates, target yield at the seeding rate for the planned product, trait stack of the planned product, and possibly other phenological properties of the planned product, including days to maturity. Crop rotation may be included to account for pressures that go along with, e.g., corn-on-corn rotation. Multiple previous year's yield may be included as a surrogate for a field's “yield potential” (e.g., last year's yield is correlated with next year's yield largely due to similar environments and management practices) as well as a surrogate for the nutrients removed from or added to the soil by last year's crop. Field acreage may also be included. Weather may be included; for example, precipitation and temperature are significant drivers of yield. Further, soil features including texture type, field capacity, wilting point, cation exchange capacity (CEC), organic matter (OM), and potential hydrogen (pH) may be included.

In some embodiments, the received data at block 702 can be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs. It should be appreciated that other processing can be performed to, for example, extract desirable features and create desired data structures before the processed data is provided to the machine-learning model in block 704.

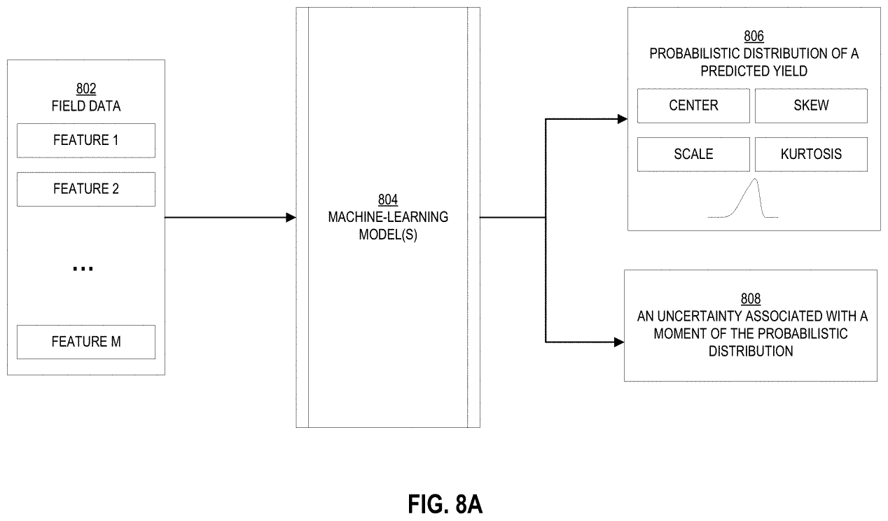

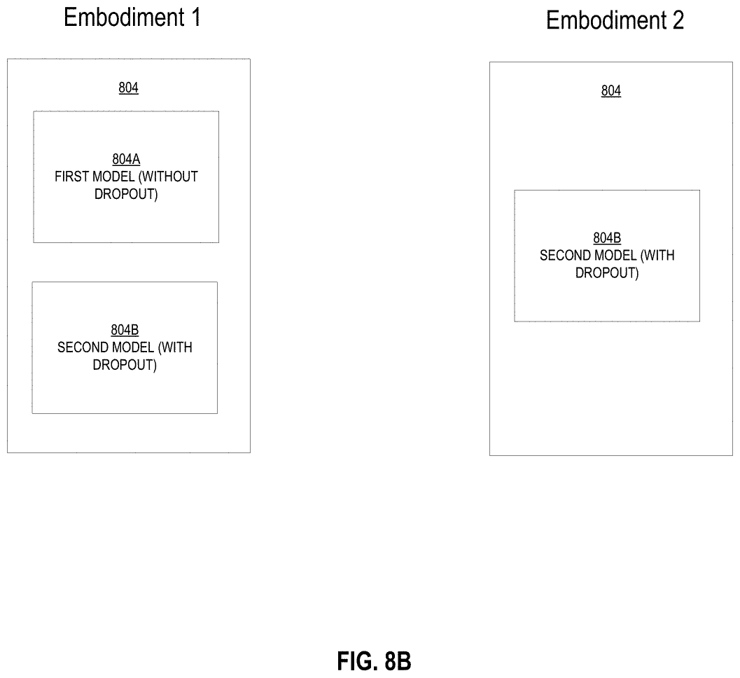

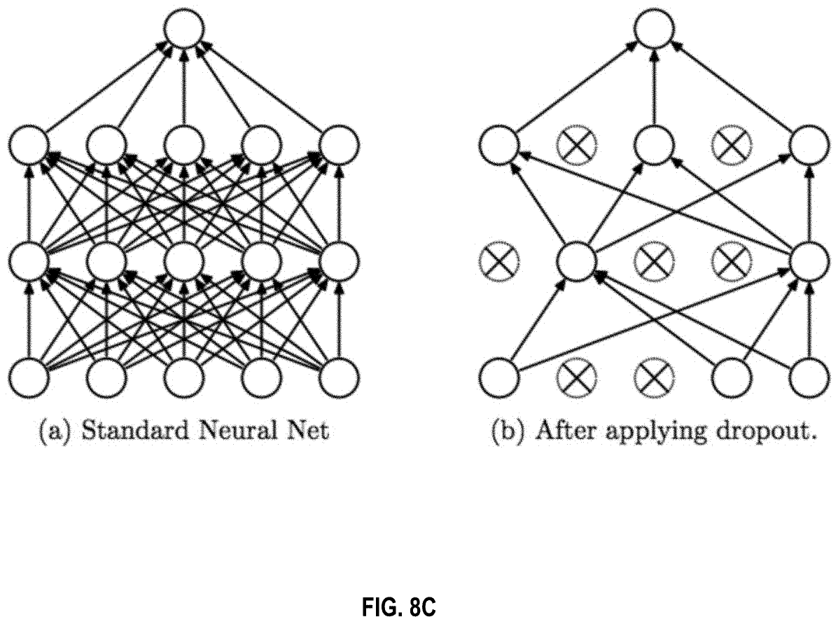

At block 704, the system provides the data to one or more trained machine-learning models. FIG. 8A illustrates exemplary machine-learning models, in accordance with some embodiments. The machine-learning model(s) 804 is configured to receive field data 802, which comprises a plurality of features 1-M. The field data 802 can be the data received at block 702 of FIG. 7. The machine-learning model(s) are configured to output a predicted yield 806 and an uncertainty 808 associated with the predicted yield 806, as described in detail below.

The machine-learning model(s) have been trained using various data about agricultural fields (e.g., similar to the data described with reference to block 702), the historical harvested crop yields of the agricultural fields, planting information (e.g., seed product and density), management information, information about the seed (e.g., description of its trait, etc.), information about the field environment (e.g., data on the soil and elevation), the growing season (e.g., weather data or features derived from weather data), etc. For example, the training data can include grower data obtained or accessed via the platform described above. In one exemplary implementation, the model(s) can be trained on 6 years (2013-2018) of plot-level grower data in the U.S. corn belt (e.g., ND, SD, NE, KS, MN, IA, MO, WI, MI, IL, KY, IN, OH). Plot-level can refer to yield aggregated to the field-product-density level, where density is binned to 1000 seeds per acre. Each field is assigned a single product and seeding rate (with the exception of some fields getting a variable-rate script). In some embodiments, anomalous data are identified and excluded from the training data, such as atypical-sized plots.

The training data can be historical data of similar types to the data described in block 702. For example, the training data can further include: seeding rates, target yield at the seeding rate for a recommended product, trait stack of the recommended product, and other phenological properties of the recommended product, including days to maturity. Crop rotation may be included to account for pressures that go along with, e.g., corn-on-corn rotation. Yields from multiple previous years may be included as a surrogate for a field's “yield potential” (e.g., last year's yield is correlated with next year's yield largely due to similar environments and management practices) as well as a surrogate for the nutrients removed from the soil by last year's crop. Field acreage may also be included as a feature. While acreage is not necessarily predictive of the expected yield outcome, it is predictive of the uncertainty around that expectation; for example, smaller fields may have larger variance than bigger fields. Weather may be included; for example, precipitation and temperature are significant drivers of yield. Further, soil features including cation exchange capacity (CEC), organic matter (OM), and potential hydrogen (pH) may be included. In some embodiments, the training data is pre-processed to generate data features based on the configuration of the model before being used to train the model. For example, the system may take information about the trait characteristics of a given seed and map it to a courser trait groups (each group comprising a number of trait characteristics). As another example, the system can generate features including information derived from trail data, which provides information about how a given seed may perform in a given grower's field.

At block 706, the system determines, based on the one or more trained machine-learning models, a probabilistic distribution of a predicted agricultural yield of the location. With reference to FIG. 8A, the machine-learning model(s) 804 is configured to output a probabilistic distribution of a predicted yield 806. The probabilistic distribution is not a single yield value, but a function that provides the probabilities of occurrence of different possible outcomes (i.e., different agronomic yields). The function that defines the probability distribution can be a probability density function (PDF).

In the depicted example in FIG. 8A, the probabilistic density function is a sinh-arcsinh (SHASH) distribution. The SHASH distribution is a type of a probability distribution, which is a function that provides the probabilities of occurrence of different possible outcomes. The SHASH distribution can be defined by four parameters: center, skew, scale, and kurtosis. Thus, given field data 802, the machine-learning model(s) 804 is configured to output four predicted SHASH parameters: a predicted center, a predicted skew, a predicted scale, and a predicted kurtosis, which in aggregate define a predicted SHASH distribution. It should be appreciated that the outputted PDF 806 is not limited to a SHASH distribution, but rather than can be any type of probabilistic distribution, parameterized (e.g., Normal, Gamma, etc) or unparameterized (e.g., quantile regression).

At block 708, the system determines, based on the one or more trained machine-learning models, an uncertainty associated with a moment of the probabilistic distribution. With reference to FIG. 8A, the machine-learning model(s) 804 is configured to output an uncertainty 808 associated with a moment of the probabilistic distribution 806. The moment of the distribution 806, for which uncertainty is calculated, can be any of the four SHASH parameters: center, skew, scale, or kurtosis. Additionally or alternatively, the moment can be the mean, the variance, the expectation, or other values defining the shape of the probabilistic distribution 806.

In some embodiments, the model 804 is a neural network, and calculating the uncertainty of a moment of the probabilistic distribution 806 involves using dropout as a Bayesian approximation. As described herein, a neural network with dropout applied before every weight layer is equivalent to an approximation to the probabilistic deep Gaussian process. Embodiments of the present disclosure apply dropout to a model configured to output a probabilistic distribution (e.g., model 804 configured to output a PDF 806). Further, embodiments of the present disclosure can calculate the uncertainty of any moment of the output probabilistic distribution (e.g., expectation value of the PDF 806), as described herein with reference to blocks 710-714 of FIG. 7.

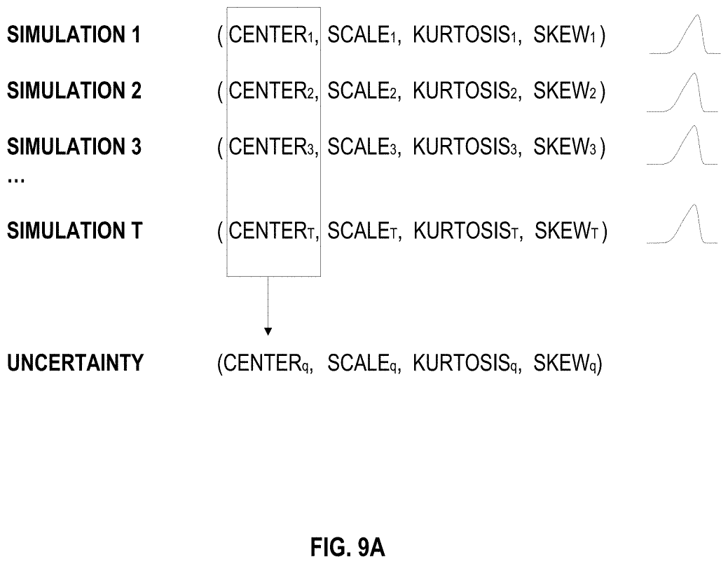

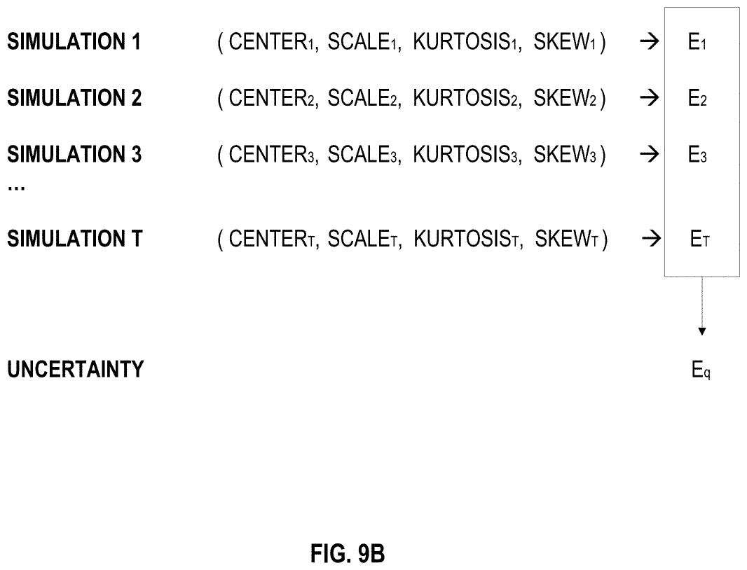

At block 710, the system can perform a plurality of simulations to obtain a plurality of simulated probabilistic distributions. FIG. 9A illustrates the results of an exemplary plurality of simulations, according to some embodiments. As shown, T number of simulations can be performed on the machine-learning model (e.g., model 804) to produce T number of simulated SHASH distributions. Each SHASH distribution i is defined by a respective set of SHASH parameters (i.e., centerᵢ, scaleᵢ, kurtosisᵢ, skewᵢ). For each parameter (e.g., center), the simulated values (e.g., Center₁-Center_{T}) are empirical realizations of the parameter.

The T simulations involve repeatedly simulating variance of how weights are calculated to show the predicted probabilistic distribution variance, thereby showing how confident the model is when predicting for a given geographic location (e.g., a field). Specifically, the T simulations involve performing T stochastic forward passes through the model and analyzing the moments for statistics. In each simulation, a network unit (e.g., a hidden unit) can be perturbed (e.g., dropped) to provide a simulated probabilistic distribution.

Dropout is a known regularization technique for reducing overfitting in machine-learning models (e.g., neural networks) by preventing complex co-adaptations on training data. It is an efficient way of performing model averaging with neural networks. In some embodiments, dropout involves randomly “dropping out,” or omitting, units (both hidden and visible) in a neural network. In other words, dropout refers to ignoring units (i.e. neurons), which is chosen at random. When a unit is ignored, the unit is not considered during a particular forward or backward pass. More technically, individual nodes are either dropped out of the net with probability 1-p or kept with probability p, so that a reduced network is left; incoming and outgoing edges to a dropped-out node are also removed. FIG. 8C illustrates an exemplary application of dropout. The model on the left represents a standard neural network model with 2 hidden layers. The model on the right represents an example of a thinned net produced by applying dropout to the network on the left. Crossed units have been dropped. By dropping a unit out, the system temporarily removes it from the network, along with all its incoming and outgoing connections, as shown in FIG. 8C. The choice of which units to drop is random.

Applying dropout to a neural network amounts to sampling a “thinned” network from it. The thinned network consists of all the units that survived dropout. A neural net with n units, can be seen as a collection of 2ⁿ possible thinned neural networks. These networks all share weights so that the total number of parameters is still O(n²), or less. For each presentation of each training case, a new thinned network is sampled and trained. So training a neural network with dropout can be seen as training a collection of 2ⁿ thinned networks with extensive weight sharing, where each thinned network gets trained very rarely, if at all.

To use dropout to determine uncertainty, the system samples binary variables for every input point and for every network unit in each layer (apart from the last one). Each binary variable takes value 1 with probability pᵢ for layer i. A unit is dropped (i.e., its value is set to zero) for a given input if its corresponding binary variable takes value 0. The system uses the same values in the backward pass propagating the derivatives to the parameters. Additional details regarding the application of dropout can be found in Gal, 2016, “Dropout as a Bayesian Approximation: Representation Model Uncertainty in Deep Learning,” Proceedings of the 33^{rd} International Conference on Machine Learning, New York, N.Y., published in Journal of Machine Learning Research, W&CP volume 48, available at https://arxiv.org/pdf/1506.02142.pdf, which is incorporated by reference in its entirety.

It should be appreciated by one of ordinary skill in the art that, the model described in the Gal paper is not a model configured to output a probabilistic distribution (e.g., model(s) 804). In contrast, it is a model that is configured to provide a single output, and Gal contemplates obtaining a predictive distribution for that single output by applying dropout. Accordingly, Gal does not apply dropout to a model that is configured to output a probabilistic distribution (such as a SHASH distribution), and Gal does not describe or contemplate obtaining a predictive distribution for a particular moment of the output probabilistic distribution as described herein. Further, Gal only applies to deep neural networks while techniques described herein can be applied to any probabilistic models.

At block 712, the system obtains a plurality of moment values associated with the plurality of simulated probabilistic distributions. At block 714, the system calculates the uncertainty associated with the moment based on the plurality of moment values.

For example, a moment of the predicted distribution can be one of the parameters defining the distribution (e.g., distribution 806 in FIG. 8A): center, scale, kurtosis, and skew. As shown in FIG. 9A, the system can obtain a plurality of center values Center₁-Center_{T}. Each center value corresponds to a particular simulation (i.e., a particular dropout applied). Center₁-Center_{T} form a predictive distribution of the center. Based on Center₁-Center_{T}, an uncertainty measure associated with the center of PDF 806 can be calculated. In some embodiments, the uncertainty measure is the standard deviation of Center₁-Center_{T}. It should be appreciated that the uncertainty measure can be other characteristics of Center₁-Center_{T}, such as variance or another statistical measure.

As another example, a moment of the predicted distribution can be the expectation value or another value characterizing the PDF 806. As shown in FIG. 9B, the system can obtain a plurality of expectation values E₁-E_{T} from on the T simulations. E₁-E_{T} form a predictive distribution of the expectation value. Based on E₁-E_{T}, an uncertainty measure associated with the expectation value of PDF 806 can be calculated. In some embodiments, the uncertainty measure is the standard deviation of E₁-E_{T}. It should be appreciated that the uncertainty measure can be other characteristics of E₁-E_{T} as described above.

With reference to FIGS. 8A and 8B, machine-learning model(s) 804 can include one or more trained machine-learning models. As shown in FIG. 8B, in a first embodiment, the machine-learning model(s) 804 comprise a first model 804A configured to output the probabilistic distribution of a predicted yield 806, and a second model 804B configured to output the uncertainty 808. The first model 804A can be trained without applying dropout. The second model 804B is trained with dropout applied. During the inference stage, the field data 802 is received by the first model 804A to output the probabilistic distribution 806. Further, the field data 802 is received by the second model 804B; T simulations are performed using the second model 804B to obtain the uncertainty 808.

With reference to FIG. 8B, in a second embodiment, the machine-learning model 804 comprises a single model 804B. The model 804B is trained with dropout and the method is configured to output both the predicted probabilistic distribution 806 and the uncertainty 808. During the inference stage, T simulations are performed using the model 804B, for example, as shown in FIG. 9A. The predicted probabilistic distribution 806 is generated based on the T simulations. For example, the center of the predicted probabilistic distribution 806 can be calculated as an average (e.g., mean, medium) of Center₁-Center_{T}, while the uncertainty associated with the center is calculated as a standard deviation of Center₁-Center_{T} as described above.

In some embodiments, the system determines or optimizes a value for T (i.e., the number of forward passes) such that it is relatively small (and thus computationally efficient) while large enough to obtain a sufficiently accurate model uncertainty. For example, the system can use a smaller T value and a larger T value and determine whether the two produce comparable results (mean, range, and standard deviation estimates for the four parameters and the SHASH expectation of a random sample of fields in the training dataset). In one experiment, the system runs the model (e.g., model 804B) with dropout rate (0.1) with both T=100 and T=1000. In another experiment, the system runs 10,000 samples with dropout rates {0.05, 0.1, 0.2, 0.5} with both T=100 and T=1000.

In some embodiments, the system determines a dropout rate. In some embodiments, the system checks for dropout rate at different levels (e.g., 0.05, 0.1, 0.2, 0.5) and determine the global average level of uncertainty measured for the four parameters and the SHASH expectation.

4.2 Generalization

While the model in FIG. 7 is configured to predict a probabilistic distribution of an agricultural yield of a location, the techniques described herein can be applied to any model configured to output a probabilistic distribution of an agronomic metric, such as fungal disease probability, seed optimization, irrigation needs, and nitrate availability.

Further, while the model in steps 704-706 of FIG. 7 is described as a machine-learning model (e.g., a neural network), any type of probabilistic model can be used, including parametric and non-parametric models. The model may be a regression model, such as a generalized additive model (GAM), a tree-based model, a machine-learning model, or other types of model. The model may be stochastic (e.g., multiple model predictions using the same input variables may be different and random). Further, the output SHASH distribution may be replaced by other distributions, parameterized (e.g., Normal, Gamma, etc.) or unparameterized (e.g., quantile regression).

Further still, while calculation of uncertainty is described with reference to a neural network with dropout applied in steps 708-714, it should be appreciated that the process is not so limited. For example, the plurality of simulations can be performed by bootstrapping. Bootstrapping is a statistical procedure that resamples a single dataset with replacements to create many simulated samples. By bootstrapping, a plurality of simulated probabilistic distributions can be obtained. At blocks 712 and 714, the system can then obtain a plurality of moment values and calculate the uncertainty associated with the moment. Bootstrapping applies to all of the models described herein. The use of dropout to approximate Bayesian uncertainty can be applied to neural networks and regression models.

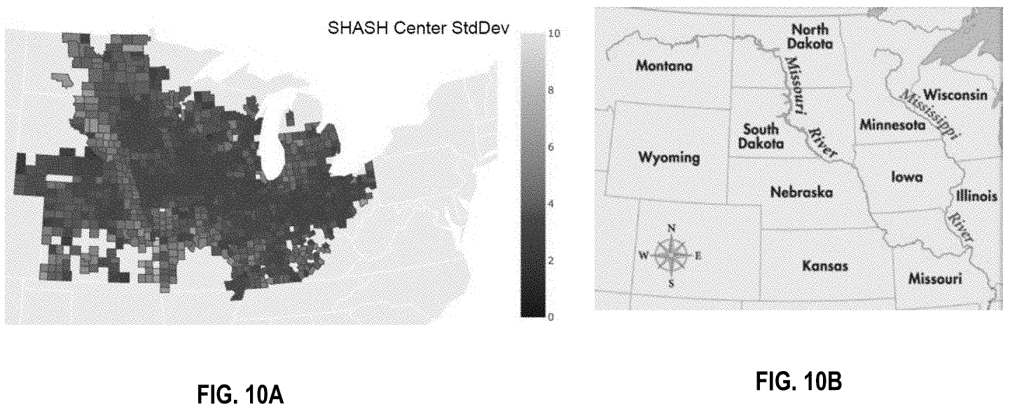

FIG. 10A illustrates a diagram of uncertainty values corresponding to a plurality of geographic regions, in accordance with some embodiments. In FIG. 10A, a probabilistic distribution is obtained (e.g., using model 804) for the geographic region in each color block on the map, and the color in each color block on the map indicates the uncertainty value associated with the center of the corresponding probabilistic distribution. A side-by-side comparison between FIG. 10A and FIG. 10B shows that the model is relatively uncertain with respect to areas along the Missouri River. In some embodiments, the geographical visualization in FIGS. 10A and 10B can be displayed on an end-user device, for example, via an instance of CLIMATE FIELDVIEW.

In some embodiments, the uncertainty values of multiple locations can be aggregated. For example, the uncertainty values of multiple fields can be aggregated to obtain an uncertainty value of a county.

4.3 Evaluating and Improving Model Performance

The various outputs described with reference to FIGS. 7-10B can be compared against empirical observations to reveal insight of the modeling process and further improve the modeling process.

In some embodiments, the expectation value of the probabilistic distribution (e.g., probabilistic distribution 806) of a field can be compared against the actual yield of the field. A large discrepancy between the expected yield and the actual yield indicates a large error in the prediction.

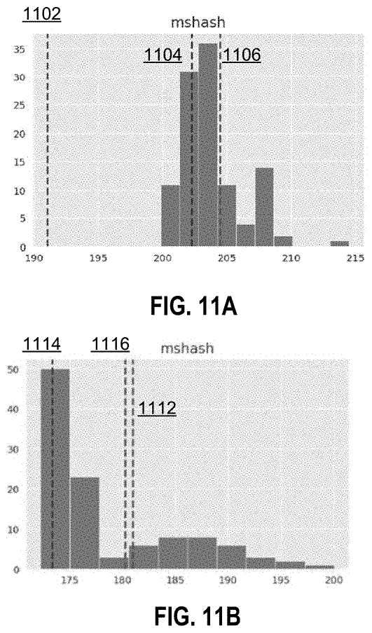

FIGS. 11A-B illustrate how a trained model (e.g., model 804 of FIG. 8A) can be evaluated (e.g., by a developer of the model before the model is deployed to serve end users). As discussed below, based on a comparison between the outputs of the model and empirical observations, the system can determine whether to deploy the model or train the model further.

FIG. 11A illustrates an exemplary scenario in which the model is overconfident, in accordance with some embodiments. In FIG. 11A, simulated SHASH expectation values (e.g., E₁-E_{T} in FIG. 9B) are represented by red bars, the average of the simulated expectation values is represented by the red dash line (rightmost line), the predicted expectation value (e.g., expectation of distribution 806) is represented by the blue dash line (middle line 1104), and the observed yield is represented by the green dash line (leftmost line 1102). As shown, there is a fairly concentrated distribution of simulated expectation values, but the green line 1102 is relatively far from the red line 1106 and blue line 1104. In other words, the observed yield appears unlikely according to the distribution of simulated expected values. The figure illustrates a scenario in which the model has a narrow distribution deviation (meaning the model is highly certain) but produces a systemically large error with respect to the observed yield. In accordance with a determination that the model is overconfident (e.g., the error exceeds a first predefined threshold and the uncertainty is below a second predefined threshold), the model outputs are not used for further processing (e.g., not displayed, not provided to the end user, not provided to another model, not used to operate agricultural implements).

The first predefined threshold can be set to be an error value above which the prediction is considered to be erroneous by the system. For example, percentile of 0.01 can be used as a threshold for determining whether the observed yield is unlikely (i.e., erroneous) according to the distribution of simulated expected values. The second predefined threshold can be set to be an uncertainty value below which the prediction is considered to be certain by the system. If the uncertainty value is below the second predefined threshold, it signifies that the system is sufficiently certain of the prediction. For example, the second predefined threshold can be set to a predefined number of standard deviations (e.g., 3). Alternatively, measures based on yield range (e.g., 15 bu/ac) or the coefficient of variation of the SHASH distribution can also be used. In some embodiments, exact deviation metrics and cutoff can be established to tailor them to revenue simulations.

FIG. 11B illustrates an exemplary scenario in which the model is uncertain, in accordance with some embodiments. In FIG. 111B, the green line 1112 is the rightmost line, the redline 1116 is the middle line, and the blue line 1114 is the leftmost line. For samples for which the distribution of the simulated SHASH expectations produced by the model has a significant standard deviation (e.g., higher than 5 standard deviations, ranges larger than 25 bu/ac, etc.), the model is uncertain. In accordance with a determination that the model is uncertain, the outputs of the model are not used for further processing (e.g., not displayed, not provided to the end user, not provided to another model, not used to operate agricultural implements) and further training using new training data may be needed. In some examples, additional training data is obtained, and the model is retrained using the additional training data. In some examples, the model is trained iteratively using new training data sets until the uncertainty measure is below a predefined threshold.

If the model is neither overconfident nor uncertain, the system may use the outputs of the model for further processing (e.g., as described under Use of Model Outputs).

4.4. Use of Model Outputs

The probabilistic distribution of a predicted yield (e.g., probabilistic distribution 806) can allow field managers to make more informed farming decisions and update their farming practices accordingly. For example, the PDF 806 can be used to compute a guaranteed yield value. For example, the system can select a particular yield value from the probabilistic function such that the likelihood of the actual yield being lower than the yield value based on the probabilistic distribution is a particular percentage, such as 10%. Additionally or alternatively, the system can compute probabilities of yield being within a particular range, such as between 150-175 bu/acre. The system can select a range with a 90% likelihood of yield and compute the guaranteed yield value as the bottom value of the range.

Further, the probabilistic distribution of a predicted yield can be used in order to recommend seeds and other farming practices, improve trials based on the expected outcome of a whole farm, and operate farming equipment or implements accordingly. Probabilistic yield predictions can be made by using a predicted probability density function (PDF) for field-level yield given prescribed genetics and management practices before planting. Depending on the expected outcomes corresponding to different sets of input data (e.g., different farming strategies), a recommended farming plan (e.g., regarding crop, irrigation, planting, fertilizer, fungicide, pesticide, farming equipment/implement operation, harvesting and other crop management plans) can be provided to field managers. For example, the recommended plan may include: seeds, hybrids, seeding rates, target yield at the seeding rate for the planed product, trait stack of the recommended product, other phenological properties of the planed product, including days to maturity, and operations of agricultural implements. The farmer can carry out the recommended plan and adopt recommended farming practices described above in his or her field. In some examples, uncertainty measures associated with various predicted yields can be provided to the user (e.g., the farmer) such that they can decide to act accordingly. A high uncertainty measure may lead the farmer to ignore the prediction; a low uncertainty may lead him to rely on the prediction, for example for investments planning. In some examples, uncertainty measures can be used by the system to rank or prioritize different farming recommendations/plans presented to the user.

The uncertainty associated with a moment of the probabilistic distribution can be used to determine the risk of the recommendation. A higher uncertainty value indicates a riskier recommendation, while a lower uncertainty value indicates a less risky recommendation. For example, if the uncertainty value (e.g., a standard deviation associated with a moment of the PDF) is close to 0, it indicates that the recommendation based on the yield prediction is less risky. In some embodiments, pricing of the recommendation (e.g., the base price, the risk premium) can be adjusted based on the uncertainty value(s) associated with the moment(s) of the probabilistic distribution.

In some embodiments, the techniques described herein can be used to generate pricing models and affect agronomic practices. For example, the system can recommend an agronomic management plan (e.g., specific seeds and seeding density) for a collection of fields belonging to a single operation. Based on the agronomic management plan, the system can use the model(s) described herein to predict what the potential yields would be at the fields. The predicted yields can be aggregated up to the operation level, thus generating a probabilistic yield prediction at the operation level. Based on this operation-level probabilistic yield prediction, the system can compute various statistics of interest, such as the expected yield (e.g., the mean of the probability distribution), the probability that the yield will be below a certain threshold X bu/ac, etc. The information can be used to design an operation-specific pricing model associated with the agronomic management plan. For example, the system may use the expected value of the yield to set an operation-specific baseline prize and offer to provide the grower a rebate if the yield ends up being below a given threshold X bu/ac. Hence, various characteristics of the operation-level probabilistic yield can be used to create an operation-specific tailored pricing. In some embodiments, the system can provide recommendations to a farmer such that there is X % probability that the yield will be between A and B, along with an associated risk determined from the uncertainty calculation. Based on the associated risk determined from uncertainty calculation, pricing models can be generated for the pricing agreements made with the farmers. For example, a higher risk may result in a lower pricing model.

Furthermore, the techniques described herein may be used for seed recommendations and seed performance comparisons. For example, for a given field, the system may carry out probabilistic yield prediction for a collection of seed products that the grower may consider for the field. The system can then use the corresponding yield distributions to narrow the collection to a subset of seed products and provide some additional information about their relative performance and the corresponding uncertainty. For example, if there are 20 potential seed products for the field, the system can use the model(s) described herein to predict a yield (in the form of a probabilistic distribution) for seed N₁, a yield (in the form of a probabilistic distribution) for seed N₂, . . . a yield (in the form of a probabilistic distribution) for seed N₂₀. The system may then determine, for example, that seed N₁ would provide the highest yield, that seed N₃ would provide the highest yield, etc. The risks associated with the predicted yields can also be factored in. The system can then recommend the seeds associated with higher predicted yields and lower risks and the farmers can plant accordingly.

The systems and methods described herein improve the operation of agricultural implements performing tasks on agricultural fields. In some embodiments, the recommendation and the associated certainty value may be used to determine how to control an agricultural implement performing future activities on the field. In some embodiments, if a recommendation is determined to be risky (e.g., if the uncertainty value exceeds a predefined threshold as described above), the recommendation may be forgone or altered (e.g., performed at a lower frequency) by the agricultural implement. In contrast, if a recommendation is determined to be not risky (e.g., the uncertainty value is lower than the predefined threshold), the recommendation may be initiated and performed by the agricultural implement. The recommendation may be used to generate computer readable instructions which, when executed by an application controller of an agricultural implement, cause the application controller to control an operating parameter of the agricultural implement to cause the agricultural implement to perform a task accordingly. In other embodiments, graphical user interfaces can be generated based on the outputs of the model, such as visualizations of the predicted yields, the uncertainty values, and the recommendations.

In some examples, the system acquires recommendation data relating to a crop management activity to be conducted at a location. The system provides information associated with the location, including the acquired recommendation data, to one or more trained machine-learning models described herein. Based on the models, the system determines the predicted crop yield of the location comprising a probabilistic distribution (defined by a plurality of parameters) and an uncertainty measure associated with a moment of the probabilistic distribution of the predicted crop yield. If the uncertainty measure does not exceed a predefined threshold (i.e., the recommendation is not risky), the system displays the recommendation data. If, on the other hand, the uncertainty measure exceeds a predefined threshold, the system foregoes displaying the recommendation data.

In some embodiments, the system iteratively provides different recommendation data to the model in order to optimize the recommendation. For example, after each iteration, the system determines whether the predicted yield exceeds a minimum yield threshold (e.g., whether a parameter of the output probabilistic distribution exceeds a minimum yield threshold) and whether the uncertainty measure does not exceed a maximum uncertainty threshold. If the conditions are not satisfied, the system can obtain new recommendation data (e.g., by adjusting the previous recommendation data) and provide it to the model. The process can be performed iteratively until both conditions are satisfied, and the optimized recommendation data can be provided to the user. The recommendation may be used to generate computer readable instructions which, when executed by an application controller of an agricultural implement, cause the application controller to control an operating parameter of the agricultural implement to cause the agricultural implement to perform a task accordingly. In other embodiments, graphical user interfaces can be generated based on the outputs of the model, such as visualizations of the predicted yields, the uncertainty values, and the recommendations.

Thus, the systems and methods described herein improve the operation of agricultural implements performing tasks on agricultural fields. Technical benefits of the systems and methods described herein include enabling agricultural implements to perform tasks in an intelligent and efficient manner by adopting improved recommendations and automatically modifying adoption of recommendations (e.g., based on the uncertainty values), thereby resulting in improved agricultural practices and yields.

4.5 Model Training

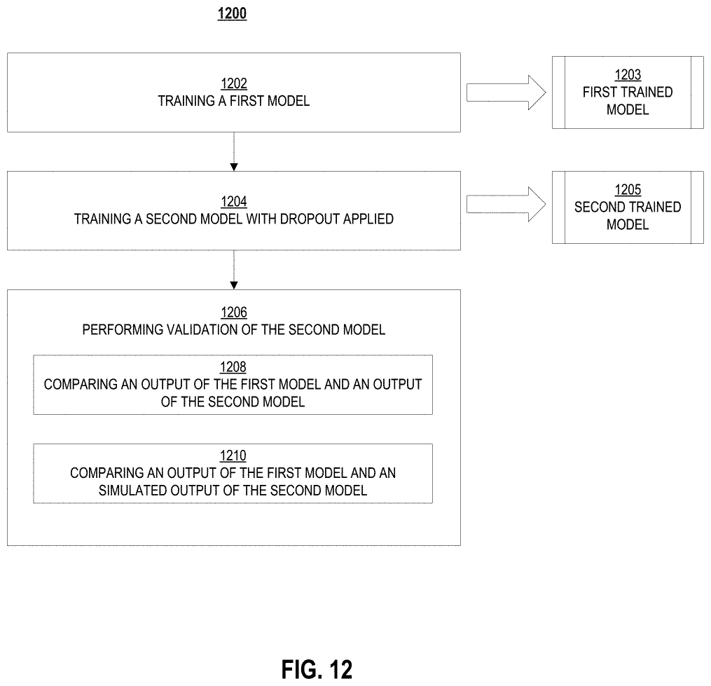

FIG. 12 illustrates an exemplary process for training computer models (e.g., model(s) 804 in FIG. 8A) for determining a probabilistic distribution of a predicted agricultural yield of a location and uncertainty associated with the probabilistic distribution. Process 1200 is performed, for example, using one or more electronic devices implementing a software platform. In some examples, process 1200 is performed using a client-server system, and the blocks of process 1200 are divided up in any manner between the server and one or more client devices. Thus, while portions of process 1200 are described herein as being performed by particular devices, it will be appreciated that process 1200 is not so limited. In some examples, process 1200 is performed using only a client device or only multiple client devices. In process 1200, some blocks are, optionally, combined, the order of some blocks is, optionally, changed, and some blocks are, optionally, omitted. In some examples, additional steps may be performed in combination with the process 1200. Accordingly, the operations as illustrated (and described in greater detail below) are exemplary by nature and, as such, should not be viewed as limiting.

At 1202, a first model is trained with a training data set to obtain a first trained model 1203. The first trained model is configured to receive data associated with a location (e.g., a field) and output a probabilistic distribution of a predicted agricultural yield of the location. In some embodiments, the first model is a neural network model trained without dropout applied, for example, model 804A in FIG. 8B.

At 1204, a second model is trained to obtain a second trained model 1205. The second trained model is configured to receive data associated with a location (e.g., a field) and output a probabilistic distribution of a predicted agricultural yield of the location. In some examples, the first model and the second model are trained using the same training data. In some examples, the first model and the second model are trained using different training data. In some embodiments, the first model is a model with dropout applied between learned parameters of the model such as in a neural network or generalized additive model, for example, model 804B in FIG. 8B. In some embodiments, the second model is trained by adding a dropout layer to an instance of the first trained model. As discussed above, the use of dropout, a regularization technique to avoid overfitting, can be interpreted as a Bayesian approximation of a Gaussian process. During the inference stage, uncertainty can be obtained by running T number of forward passes (i.e., simulations) using the second trained model with different hidden units dropped according to a dropout rate applied for each simulation. In some embodiments, the random seed for dropout is randomized between forward pass iterations (e.g., in both training and inference).

At block 1206, validation of the second trained model is performed. In some embodiments, the first trained model is also validated. Validation can be performed using a dataset comprising historical yield data that is different from the training dataset. In some embodiments, at block 1208, the system compares an output of the first trained model and an output of the second trained model. For example, the system checks that the two models produce comparable SHASH distribution predictions (e.g., comparable center values). In some embodiments, at block 1210, the system compares an output of the first model and a simulated output of the second model. For example, the system checks whether the mean of center values from T simulations using the second model is comparable with the center value predicted by the first model.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

What is claimed is:

1. A computer-implemented method of predicting a crop yield for a location and uncertainty associated with the predicted crop yield, the method comprising:
receiving information associated with the location;
providing the information to one or more trained machine-learning models;
determining, based on the trained machine-learning models:
the predicted crop yield of the location comprising a probabilistic distribution of the predicted crop yield of the location, wherein the probabilistic distribution is defined by a plurality of parameters; and
an uncertainty measure associated with a moment of the probabilistic distribution of the predicted crop yield; and
outputting the predicted crop yield of the location and the uncertainty measure.

2. The computer-implemented method of claim 1, further comprising: determining a farming recommendation based on the predicted crop yield.

3. The computer-implemented method of claim 2, wherein the farming recommendation is related to crop type, irrigation, planting, fertilizer, fungicide, pesticide, harvesting, or any combination thereof.

4. The computer-implemented method of claim 1, further comprising: determining a risk associated with the farming recommendation based on the uncertainty measure.

5. The computer-implemented method of claim 1, wherein the one or more models are trained based on harvest data, soil data, planting data, fertilizing data, chemical application data, irrigation data, weather data, imagery data, scouting observations, or any combination thereof.

6. The computer-implemented method of claim 1, wherein the one or more trained machine-learning models comprise one or more neural network models.

7. The computer-implemented method of claim 6, wherein the one or more trained machine-learning models comprises a neural network trained with a dropout layer.

8. The computer-implemented method of claim 1, wherein the probability distribution is a SHASH distribution.

9. The computer-implemented method of claim 8, wherein the plurality of parameters are center, skew, scale, and kurtosis.

10. The computer-implemented method of claim 1, wherein the moment is one of the plurality of parameters.

11. The computer-implemented method of claim 1, wherein the moment is an expectation value of the probabilistic distribution.

12. The computer-implemented method of claim 1, further comprising: running a plurality of simulations using a neural network model of the one or more machine-learning models to obtain a plurality of simulated values of the moment.

13. The computer-implemented method of claim 12, wherein running the plurality of simulations comprises performing T stochastic forward passes through the neural network model, wherein a network unit of the neural network model is perturbed in each simulation of the plurality of simulations.

14. The computer-implemented method of claim 12, wherein the uncertainty measure is calculated based on the plurality of simulated values of the moment.

15. The computer-implemented method of claim 14, wherein the uncertainty measure is a standard deviation calculated based on the plurality of simulated values of the moment.

16. The computer-implemented method of claim 1, wherein the one or more machine-learning model comprise a first model and a second model, wherein the first model is used to determine the probabilistic distribution of the predicted agricultural yield of the location, and wherein the second model is used to determine the uncertainty measure.

17. The computer-implemented method of claim 1, further comprising:
running a plurality of simulations using a neural network model of the one or more machine-learning models to obtain a plurality of simulated probabilistic distributions;
based on the plurality of simulated probabilistic distributions, determining the probabilistic distribution of the predicted agricultural yield of the location; and
based on the plurality of simulated probabilistic distributions, determining the uncertainty measure associated with the moment of the probabilistic distribution.

18. The computer-implemented method of claim 1, further comprising: if the uncertainty measure exceeds a predefined threshold, obtaining additional training data to train the one or more machine-learning models and training the one or more machine-learning models based on the additional training data.

19. The computer-implemented method of claim 1, wherein the information associated with the location comprises recommendation data relating a crops management activity to be conducted at the location, the method further comprising:
determining whether the uncertainty measure exceeds a predefined threshold;
in accordance with a determination that the uncertainty measure does not exceed the predefined threshold, displaying the recommendation data; and
in accordance with a determination that the uncertainty measure exceeds the predefined threshold, foregoing displaying the recommendation data.

20. The computer-implemented method of claim 1, wherein the information associated with the location comprises recommendation data relating a crops management activity to be conducted at the location, the method further comprising:
obtaining optimized recommendation data by iteratively running the one or more trained machine-learning models using different recommendation data until the uncertainty measure does not exceed a first predefined threshold and the probabilistic distribution exceeds a second predefined threshold; and
displaying the optimized recommendation data.

21. The computer-implemented method of claim 19, further comprising: operating a farming equipment based on the recommendation data.

22. The computer-implemented method of claim 1, wherein the information associated with the location is in the form of a matrix or an array.

23. An electronic device for predicting a crop yield for a location and uncertainty associated with the predicted crop yield, comprising: one or more processors; a memory; and one or more programs, wherein the one or more programs are stored in the memory and configured to be executed by the one or more processors, the one or more programs including instructions for:
receiving information associated with the location;
providing the information to one or more trained machine-learning models;
determining, based on the trained machine-learning models:
the predicted crop yield of the location comprising a probabilistic distribution of the predicted crop yield of the location, wherein the probabilistic distribution is defined by a plurality of parameters; and
an uncertainty measure associated with a moment of the probabilistic distribution of the predicted crop yield; and
outputting the predicted crop yield of the location and the uncertainty measure.

24. A non-transitory computer-readable storage medium storing one or more programs for predicting a crop yield for a location and uncertainty associated with the predicted crop yield, the one or more programs comprising instructions, which when executed by one or more processors of an electronic device having a display, cause the electronic device to:
receive information associated with the location;
provide the information to one or more trained machine-learning models;
determine, based on the trained machine-learning models:
the predicted crop yield of the location comprising a probabilistic distribution of the predicted crop yield of the location, wherein the probabilistic distribution is defined by a plurality of parameters; and
an uncertainty measure associated with a moment of the probabilistic distribution of the predicted crop yield; and
output the predicted crop yield of the location and the uncertainty measure.
